(19) United States
(12) Patent Application Publication
(10) Pub. No.: US 2020/0015333 A1
(43) Pub. Date: Jan. 9, 2020

(54) LIGHTING DEVICE, SYSTEM AND METHOD FOR CONTROLLING A LIGHTING DEVICE

(71) Applicant: SIGNIFY HOLDING B.V., EINDHOVEN (NL)

(72) Inventors: BERND ACKERMANN, AACHEN (DE); MATTHIAS WENDT, WURSELEN (DE); GOUTAM MAJI, BANGALORE (IN); THEODORUS JOHANNES PETRUS VAN DEN BIGGELAAR, VELDOVEN (NL); HARALD JOSEF GUNTHER RADERMACHER, AACHEN (DE); PIETER JOHANNES STOBBELAAR, EINDHOVEN (NL); PRIYA RANJAN MISHRA, BANGALORE (IN); HAIMIN TAO, EINDHOVEN (NL); HENRY THEODORUS VAN DER ZANDEN, SINT-OEDENRODE (NL)

(21) Appl. No.: 16/489,042

(22) PCT Filed: Mar. 5, 2018
(86) PCT No.: PCT/EP2018/055345

§ 371 Date: Aug. 27, 2019

(30) Foreign Application Priority Data
Mar. 9, 2017 (EP) 17160153.7
Mar. 15, 2017 (EP) 17161124.7
Aug. 24, 2017 (EP) 17187749.1

(51) Int. Cl. H05B 33/08; F21K 9/278

(52) U.S. Cl. CPC H05B 33/0815; H05B 33/0845; F21K 9/278

(57) ABSTRACT

A lighting device (7) comprises an input terminal for receiving an input power, a power converter (5) for receiving the input power from the input terminal, and for transforming the input power into a charging power and a supply power, an energy storage device (11) for receiving the charging power and for providing a discharging power. The lighting device (7) further comprises an LED load (9) for receiving the supply power and the discharging power, wherein the lighting device (7) is arranged to be operated in a first mode and in a second mode, wherein in the first mode the LED load (9) is arranged to receive the supply power from the power conversion unit, and the energy storage device (11) is arranged to receive the charging power from the power converter, wherein in the second mode the LED load (9) is arranged to receive the discharging power from the energy storage device. The lighting device (7) further comprises a controller (13) for monitoring a charge level of the energy storage device, and for switching the lighting device (7) into the first mode when the charge level is below a lower threshold level (THL) and into the second mode when the charge level exceeds an upper threshold level (THU), the upper threshold level (THU) being higher than the lower threshold level (THL) and for disconnecting in the second mode the power converter (5) from the input terminal.

### FIELD OF THE INVENTION

The invention relates to a retrofit lamp for providing power to a load. The invention further relates to a system comprising the retrofit lamp.

### BACKGROUND OF THE INVENTION

Light-emitting diodes (LEDs) are used as a kind of solid-state light source. Compared with conventional lighting, such as incandescent or fluorescent lamps, its advantages are compactness, high efficacy, good color, various and variable color, etc. LEDs are widely used in indoor lighting, decoration lighting and outdoor lighting. Some of these applications require the output light of the LEDs to be adjusted from 1% to 100% of the maximum light output.

In retrofit applications, a lighting device may be connected to mains via an external device. Such external device may be a phase-cut wall dimmer, a low voltage electronic ballast or a fluorescent ballast. Such a ballast may be of the magnetic or electronic type. The power supplied by the external devices to the lighting devices is significantly lower than the nominal power that the external devices supply to their nominal load such as for example incandescent lamps, low-voltage halogen lamps, fluorescent lamps, high intensity discharge lamps. As a consequence of this, the external devices operate at a significantly reduced efficiency when loaded by a lighting device. Further, there may be compatibility issues between external devices and lighting devices. External devices have a rated minimum output power requirement. With LED loads, this minimum output power may not be reached. The external device is then unable to operate as specified.

In the field of the lighting devices, compatibility improvement with external devices is well known.

WO 2016/145264 discloses a lighting system comprising a solid state replacement lamp configured to replace a non-solid state lamp in a lamp fixture, a power supply configured to convert power drawn from the lamp fixture to power at least one solid state light, and a power output for an external electronic device connected to the solid state replacement lamp.

WO 2013/017994 discloses a driver device and a corresponding driving method for driving a load, in particular an LED unit, said driver device comprising power input terminals for receiving a periodic supply voltage from an external power supply potentially including a dimmer for dimming said periodic supply voltage, power output terminals for providing a drive voltage and/or drive current for driving a load, a power stage coupled between the power input terminals and the power output terminals for controlling an input current received from said power input terminals to draw a high power from said external power supply in a first mode or to draw a low or no power from said external power supply in a second mode, said high power being higher than the power required for driving said load and said low power being lower than the power required for driving said load, wherein said power stage controls said input current to be in the second mode only for a percentage of half cycle periods of a number of subsequent half cycle periods of said supply voltage, and for providing said drive voltage and/or drive current to said power output terminals in said first mode, and an energy storage unit coupled to said power stage for storing electrical energy provided at said power input terminals in said first mode and for providing stored electrical energy to said load via said power output terminals in said second mode.

### SUMMARY OF THE INVENTION

It is an objective of the invention to provide a lighting device, and a corresponding system comprising the lighting device and an external device, which has an improved compatibility with the external device. According to a first aspect of the present invention, a lighting device for operating with a fluorescent ballast is provided, comprising:

an elongated body having at a first side a first pair of input terminals and at a second side a second pair of input terminals for receiving an input power;

a power converter for receiving the input power from the first pair of input terminals and the second pair of input terminals, and for transforming the input power into a charging power and a supply power;

an energy storage device for receiving the charging power and for providing a discharging power;

an LED load for receiving the supply power and the discharging power;

wherein the lighting device is arranged to be operated in a first mode and in a second mode,

wherein in the first mode the LED load is arranged to receive the supply power from the power converter, and the energy storage device is arranged to receive the charging power from the power converter,

wherein in the second mode the LED load is arranged to receive the discharging power from the energy storage device,

wherein the lighting device further comprises a controller for:

monitoring a charge level of the energy storage device, and for switching the lighting device into the first mode when the charge level is below a lower threshold level and into the second mode when the charge level exceeds an upper threshold level, the upper threshold level being higher than the lower threshold level; and for

disconnecting in the second mode the power converter from the input terminal.

This lighting device has an improved compatibility when driving an LED load through a supply power coming from a power conversion circuit in a first mode. The LED load is driven by a discharging power coming from an energy storage device during a second mode. Furthermore, in the second mode, the power converter is disconnected from an input terminal. This prevents an external device connected to the lighting device to supply power to the lighting device. In the first mode, the lighting device will draw enough power to drive the LED load and additional power to charge the energy storage device. Therefore, in the first mode, the external device supplies more power than required for only the LED load, thereby improving the efficiency of the external device. Switching between the first and second mode may be performed based on a charge level of the energy storage device. The lighting device is switched in the first mode when the charge level is below a lower threshold level and switched into the second mode when the charge level exceeds an upper threshold level. The upper threshold level being higher than the lower threshold level.

In one embodiment, the energy storage device is one of a battery, a super-capacitor and a capacitor.

These preferred examples of an energy storage device allow for easy electrical energy storage and can have a large energy density.

In another embodiment, the power converter further comprises an input converter arranged between input terminals for receiving the input power from the input terminal, and for transforming the input power into a charging power and a supply power, and a bidirectional converter for providing the charging power to the energy storage device in the first mode and for providing discharge power to the LED load in the second mode.

The bi-directional converter is a single converter that is capable for providing charging power to the energy storage device in the first mode and discharge power to the LED load in the second mode. The bi-directional converter offers a simple solution for bi-directional power transfers.

In a further embodiment, the converter is a multiple output converter arranged to provide charging power to the energy storage device via one of the multiple outputs in the first mode and provide supply power to the LED load via another of one of the multiple outputs in the first mode.

The advantage is that one dedicated converter output is arranged to drive the LED load where another converter output is arranged to charge the energy storage device. This offers a simple and optimized converter topology for charging and discharging the energy storage device. Furthermore, the LEDs are driven by an optimized converter output.

In a further embodiment, the power converter comprises a switched mode power supply.

Switched mode power supplies are power converters which have a high efficiency. Examples of a switched mode power supply are: buck converter, boost converter, flyback converter and an LLC resonant converter.

In another embodiment, the controller has an input for receiving an external control signal for overruling the switching from the first mode to the second mode or the switching from the second mode to the first mode.

This allows an operator to change operation from optimized compatibility to energy management. This can be useful when energy management in e.g. a building becomes important. Energy from the energy storage device is then used to cover the energy requirements in a system.

In another embodiment, the lighting device is configured to switch the second mode when the LED load requires a power below a power threshold and when the charge level is above the lower threshold.

When the LED load requires only a fraction of its nominal power, controllability of the LED load power can be performed better when a stable input voltage is provided. In this situation, the energy storage device can provide the most stable input voltage and is therefore preferred to be used at low power consumption.

In another embodiment, the lighting device is configured to switch to the second mode when the lighting device is in stand-by, requiring a stand-by power and when the charge level is above the lower threshold.

Similar as to the low power consumption of the LED load, when the lighting device in total requires a small amount of power, e.g. when the lighting device is in stand-by, it is preferable to have a stable input voltage, which is provided by the energy storage device.

In a further embodiment, a system is provided comprising:

the lighting device as claimed in any of the preceding claims; and

an external device for providing power to the input terminals and receiving power from an AC supply.

This system has the advantage that the external device supplies power to the lighting device in optimized fashion for compatibility between the external device and the lighting device.

In another embodiment, the system is described as wherein the lighting device is arranged for drawing in the first mode the input power within a rated power range of the external device.

When the external device operates at its rated power range, the efficiency of the external device is at its largest.

In another embodiment, the external device is arranged to be one of a phase-cut dimmer, a ballast of a gas discharge lamp, a ballast of a high intensity discharge lamp and an electronic ballast. The most common used ballast is a fluorescent ballast that can be any, but not limited to, of an electromagnetic ballast and an electronic ballast.

These are the external devices that benefit most of an improved lighting device.

In a further embodiment, a method for controlling a lighting device is provided wherein the method comprises the steps of:

receiving an input power,

transforming the input power into a charging power and a supply power;

storing the charging power in an energy storage device;

supplying the supply power or a discharging power from the energy storage device to an LED load,

determining the charge level of the energy storage device;

switching the lighting device into a first mode when a charge level of the energy storage device is below a lower threshold level;

switching the lighting device into a second mode when the charge level exceeds an upper threshold level,

wherein in the first mode the supply power is supplied to the LED load, and the charging power is supplied to the energy storage device and wherein in the second mode the discharging power is supplied to the LED load.

With the help of the lighting device, the system and the method according to the embodiments of the invention, the LED load can be driven more effectively.

It has been an insight of the inventors that the lighting device can also be implemented in non-retrofit applications. An example could be that a lighting device is arranged to charge the energy storage device when the price of electricity is at a low level and discharge the energy storage device when the price of electricity is at a high level. This allows for savings in energy costs.

### BRIEF DESCRIPTION OF THE DRAWINGS

Examples of the invention will now be described in detail with reference to the accompanying drawings, in which:

FIG. 1 shows an example of a lighting device according to the invention,

FIG. 2 schematically shows a switch interrupting current flow between the external device and the lighting device,

FIG. 3 schematically shows three switches interrupting current flow between the external device and the lighting device,

FIG. 4 schematically shows four switches interrupting current flow between the external device and the lighting device,

FIG. 5 schematically shows a first topology of the internal structure of the power converter,

FIG. 6 schematically shows a second topology of the internal structure of the power converter,

FIG. 7 schematically shows a third topology of the internal structure of the power converter,

FIG. 8 schematically shows a fourth topology of the internal structure of the power converter, and

FIG. 9 shows a graph of an example of the charge over time in the energy storage device.

### DETAILED DESCRIPTION OF THE EMBODIMENTS

Lighting devices come in many different configurations. Retrofit lamps are considered to be compatible with external devices supplying power to the lighting device. Since there are several types of external devices requiring different types of load behaviors, different kind of solutions are proposed in the prior art for improving the compatibility between an LED load and an external device. The invention proposes one solution that allows compatibility for more than just one type of external device.

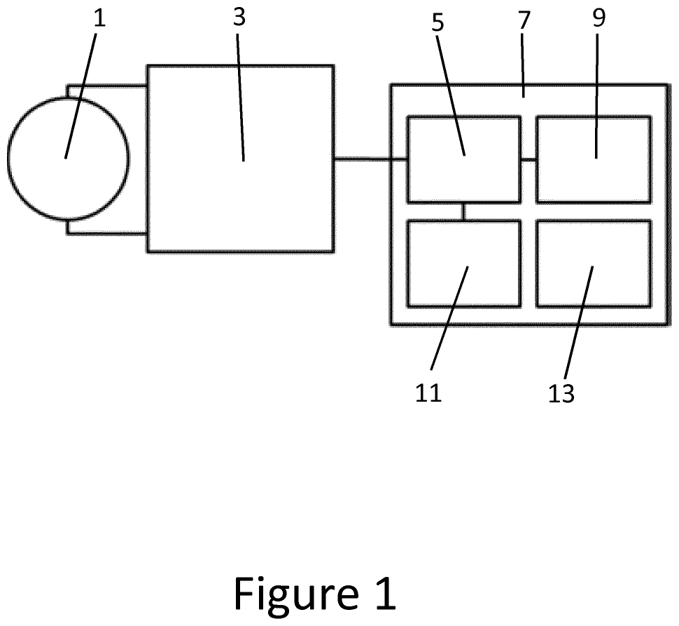

FIG. 1 shows a basic connection between a mains power supply 1 coupled to an input of an external device 3 and a connection between an output of the external device and a lighting device 7. The external device 3 may be one of a phase-cut dimmer, a low voltage transformer and a fluorescent ballast such as a magnetic or electronic ballast. The mains power supply 1 supplies a mains input voltage Vac and the external device 3 supplies an input power Pin to the lighting device 7.

FIG. 1 further shows a basic lighting device configuration according to the invention. The power converter 5 is configured to operate in two modes of operation. In the first operating mode, the power converter 5 is configured to provide power to the LED load 9 and to the energy storage device 11. In an embodiment, the power drawn from the external device 11 is equal to the nominal power of the external device 3. This allows the external device 3 to operate in its optimized operating range resulting in a more efficient and compatible transformation from a mains input voltage into an input voltage for the lighting device 7. In the second operating mode, the output power of the external device 3 is zero or almost zero. The power converter 5 supplies power from the energy storage device 11 to the LED load 9. A controller 13 may be used to toggle the power converter 5 between the first operating mode and the second operating mode.

An energy storage device 11 may be one of a battery, a super capacitor and a capacitor. In an embodiment, the energy storage device 11 is arranged such that an interruption of input power from the external device 3 of more than half a mains cycle can be bridged by energy stored in the energy storage device 11. In this case the compatibility with the external device 3 can be optimally guaranteed.

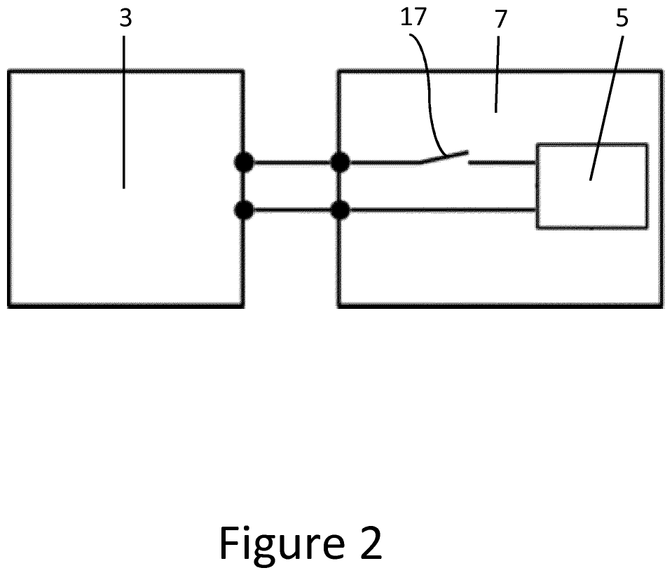

FIG. 2 shows a switch 17 interrupting current flow between the external device 3 and the lighting device 7. Since mains will remain present, the power supply to the lighting device 7 has to be interrupted actively by the switch 17. This switch 17 may also be the switch present in the power converter 5, which is used for providing power to the LED load 9 using a switched mode power supply methodology. When the current flow has been interrupted by opening the switch 17 during the second operating mode, the external device 3 operates at no load. No significant power is transferred to the lighting device 7 and therefore no additional power losses are present in the external device 3. Moreover, since the external device 3 provides no power, compatibility is not an issue. In this situation, power to the LED load 9 is provided via the energy storage device 11. The circuitry after the power converter 5 up to and including the LED load 9 has been omitted for simplicity of the figure.

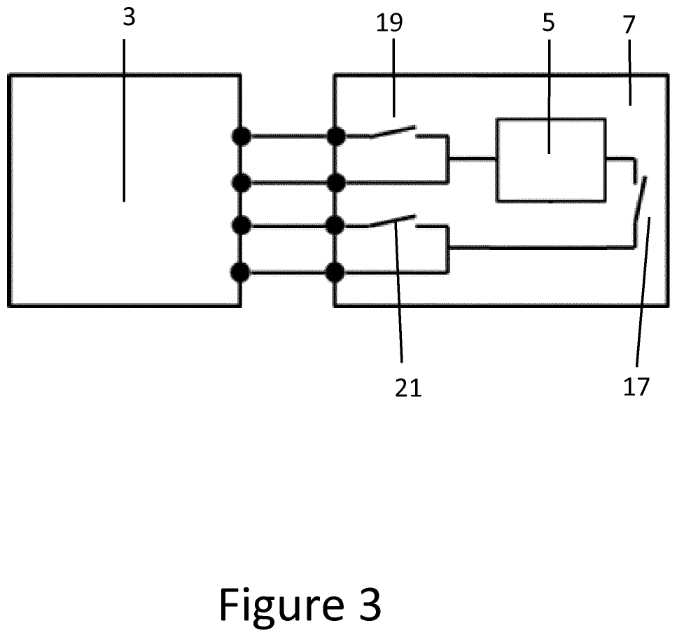

FIG. 3 shows three switches 17, 19, 21 interrupting current flow between the external device 3 and the lighting device 7. In this case, the external device 3 can be a fluorescent lamp ballast and the lighting device can be an elongated fluorescent retrofittable lighting device having at a first side a first pair of input terminals and at a second side a second pair of input terminals. Four connections are present in this case between the external device 3 and the lighting device 7. To make sure no current flows from the external device 3 towards the lighting device 7, at least three switches 17, 19, 21 are required. The first two switches 19, 21 are placed such that the so called filament current paths are interrupted. The third switch 17 is arranged such that the current path from one filament to another filament is interrupted. This current is also referred to as a lamp current. The third switch 17 may again be part of the power converter 5 of the lighting device 7. The circuitry after the power converter 5 up to and including the LED load 9 has been omitted for simplicity of the figure.

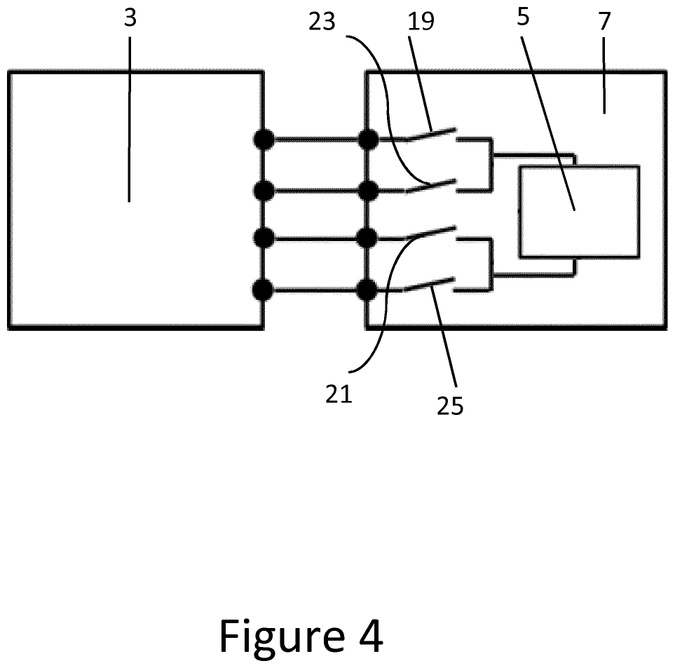

FIG. 4 shows four switches 19, 21, 23, 25 interrupting the current flow between the external device 3 and the lighting device 7. This specific embodiment provides an alternative of the proposed embodiment shown in FIG. 3. Two switches 19, 23 and 21, 25 are placed in each of the filaments such that both the filament current paths and the lamp current path are interrupted. The circuitry after the power converter 5 up to and including the LED load 9 has been omitted for simplicity of the figure.

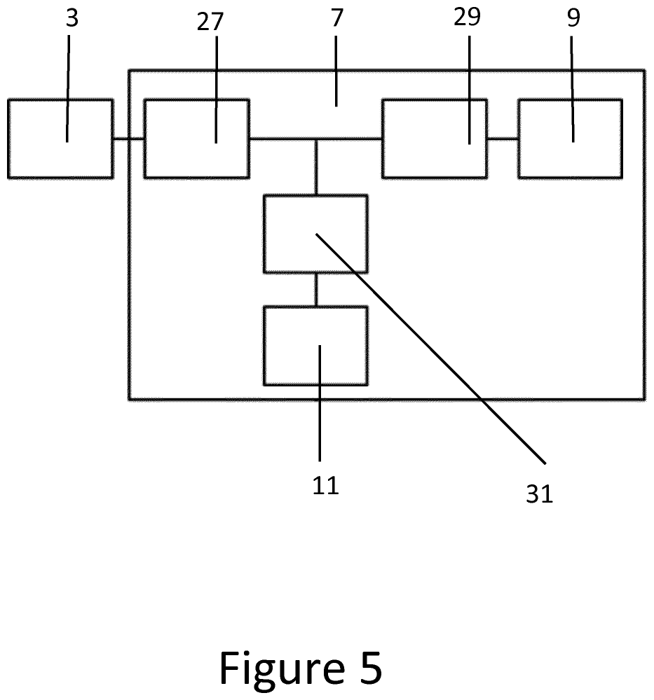

FIG. 5 shows a first topology of the internal structure of the lighting device 7. The power converter 5 comprises an input converter 27. This input converter transforms the voltage received from the external device 3 into a suitable voltage to be received by the rest of the circuitry following the input converter 27. The input converter 27 may be a rectifier circuit for rectifying an AC voltage supplied by the external device 3 or a power factor correction, PFC, circuit for improving the power factor of the lighting device 7. In the first operating mode, power is supplied from the input converter 27 to an LED driver 29, which is arranged to drive an LED load 9. Furthermore, in the first operating mode, the input converter 27 provides power to the converter 31, which is arranged to provide the power to an energy storage device 11. In this embodiment, the converter 31 may be a bi-directional converter. In the second operating mode, the converter 31 provides power from the energy storage device 11 to the LED load 9 via the LED driver 29. The converter 31 can be arranged to drive the LED load 9 directly. The LED driver 29 can then be omitted. Disconnecting of the power converter from the external device 3 in the first operating mode has to be done at the location near the input converter 27 such that energy can still flow from the energy storage device 11 to the LED load 9 in the second operating mode.

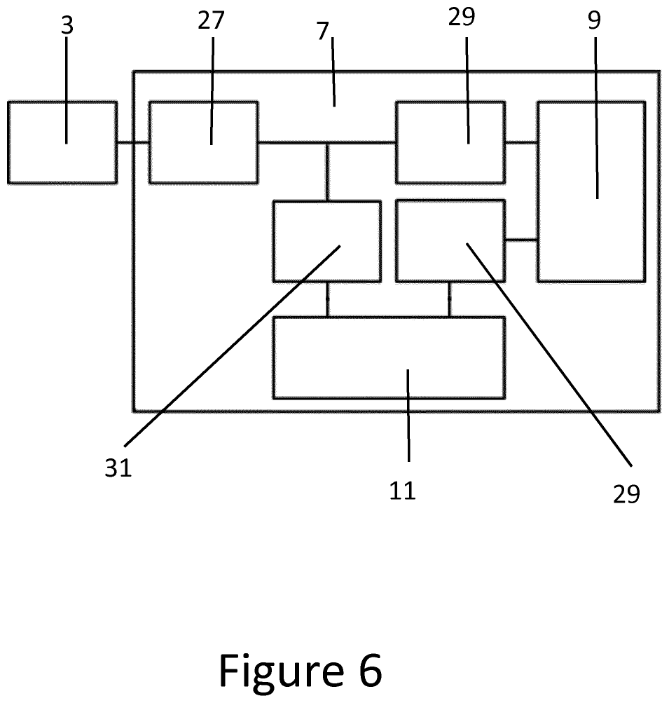

FIG. 6 shows a second topology of the internal structure of the lighting device 7. The power converter 5 comprises an input converter 27 for receiving a voltage from an external device 3. The input converter 27 may be a rectifier circuit for rectifying an AC voltage supplied by the external device 3 or a power factor correction, PFC, circuit for improving the power factor of the lighting device 7. The input converter 27 provides power to a converter 31 and a first LED driver 29 in the first operating mode. The converter 31 is arranged to charge an energy storage device 11 in the first operating mode. The energy storage device 11 provides power to a further LED driver 29 for driving the LED load 9 in the second operating mode. The first LED driver 29 may be arranged to drive the same LED load 9. The first and the second LED driver 29 may be identical but can also be of a different configuration. The LED driver 29 is used in the embodiments as a non-essential addition to the lighting device 7. The LED driver 29 may be used to improve the light output quality of the LED load 9 by stabilizing the current to the LED load 9.

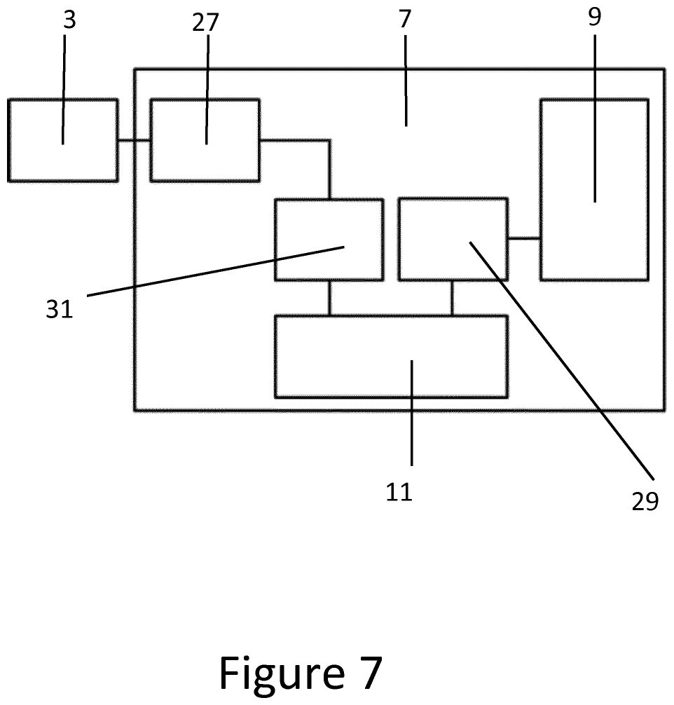

FIG. 7 shows a third topology of the internal structure of the lighting device 7. Similar to the power converter shown in FIG. 6, the power converter comprises an input converter 27 for receiving a voltage from an external device. The input converter may be a rectifier circuit for rectifying an AC voltage supplied by the external device 3 or a power factor correction, PFC, circuit for improving the power factor of the lighting device 7. The input converter 27 provides power to the converter 31. This converter 31 is arranged to charge an energy storage device 11. The energy storage device 11 provides power to an LED driver 29 for driving an LED load 9.

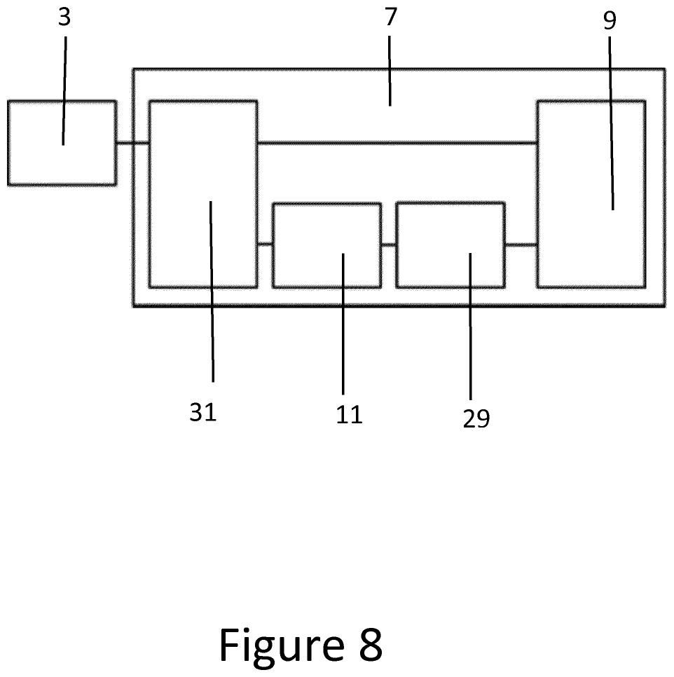

FIG. 8 shows a fourth topology of the internal structure of the lighting device 7. A converter 31 is arranged to receive a voltage from an external device. This converter 31 is a dual output converter. The converter 31 comprises at least two outputs. In the first operating mode, the converter 31 is arranged to receive power from the external device 3 and provide power via a first output to an LED load 9. Furthermore, the converter 31 provides power via a second output to an energy storage device 11. In the second operating mode, the converter 31 is arranged to block an energy flow coming from the external device 3. The energy storage device 11 provides power to an LED driver 29 arranged to drive the LED load 9. It should be noted that instead of a dual output converter, two separate converters can be used to fulfill the same function as the dual output converter.

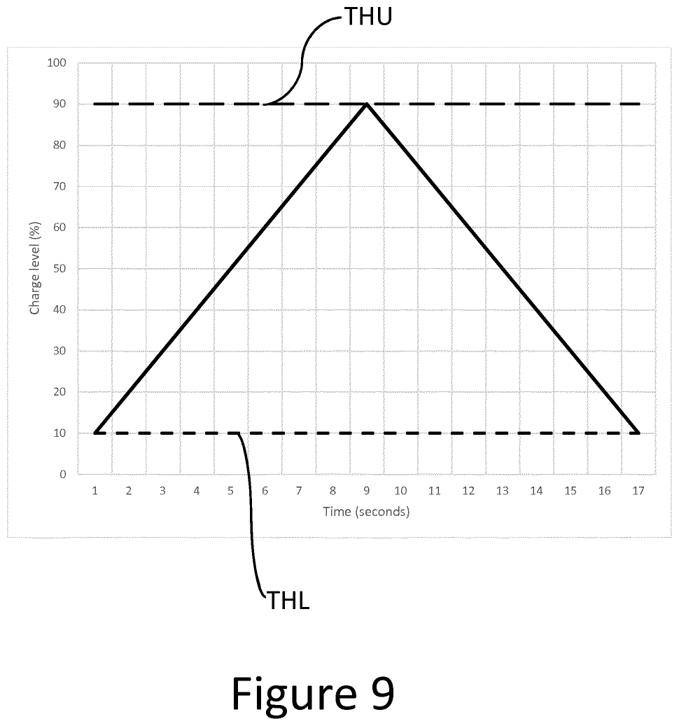

FIG. 9 shows an example of thresholds for charging and discharging the energy storage device 11. The controller 13 controls the charging and discharging of the energy storage device 11. The controller 13 may also monitor the charge level of the energy storage device 11. The controller 13 may be any of an analog control circuit, a microcontroller or an FPGA. The lower threshold THL determines when the charge level is low enough for the power converter 5 to switch into the first operating mode. In this example, the lower threshold THL is placed at a charge level of 10%. In the first operating mode, the energy storage device 11 will be charged by the power converter 5 and the LED load 9 will be supplied by the external device 11 until an upper threshold THU of charge has been reached. In this example, the upper threshold THU has been placed at a charge level of 90%. The upper threshold THU determines when there is enough charge in the energy storage device 11 to allow the power converter 5 to switch into the second operating mode. During the second operating mode, the energy storage device 11 is discharged by the power converter 5 into the LED load 9 and discharges until the lower threshold THL has been reached. The power converter 5 then switches back into the first operating mode.

The power converter 5 can furthermore be switched into the second mode when the LED load 9 requires a low amount of power, below a power threshold Plow, and when the charge level of the energy storage device 11 is above the lower threshold level THL. The power threshold Plow may be set at the level where deep dimming starts to occur.

Furthermore, the power converter 5 can be switched into the second mode when the lighting device 7 is in a stand-by mode. This results in that the lighting device 7 only requires some stand-by power. This power may be used to wake up the power converter 5 or to communicate via wireless and wired communication systems.

It should be noted that more than two operating modes can be implemented and that the waveform in the figure is merely an example.

It is further noted that a lighting device might be, but not limited to, one of a luminaire, a lighting fixture and a retrofit lamp. Preferably, the lighting device is used in a general illumination application.

1. A lighting device for operating with a fluorescent ballast comprising:
an elongated body having at a first side a first pair of input terminals and at a second side a second pair of input terminals for receiving an input power;
a power converter for receiving the input power from the first pair of input terminals and the second pair of input terminals, and for transforming the input power into a charging power and a supply power;
an energy storage device for receiving the charging power and for providing a discharging power;
an LED load for receiving the supply power and the discharging power;
wherein the lighting device is arranged to be operated in a first mode and in a second mode,
wherein in the first mode the LED load is arranged to receive the supply power from the power converter, and the energy storage device is arranged to receive the charging power from the power converter,
wherein in the second mode the LED load is arranged to receive the discharging power from the energy storage device,
wherein the lighting device further comprises a controller for:
monitoring a charge level of the energy storage device, and for switching the lighting device into the first mode when the charge level is below a lower threshold level (THL), into the second mode when the charge level exceeds an upper threshold level (THU) and into the second mode when the LED load requires a power below a power threshold (Plow) and when the charge level is above the lower threshold (THL), the upper threshold level (THU) being higher than the lower threshold level (THL); and for
disconnecting in the second mode the power converter from an input terminal.

2. The lighting device according to claim 1 wherein the energy storage device is one of a battery, a super-capacitor and a capacitor.

3. The lighting device according to claim 1 wherein the power converter further comprises:
an input converter arranged between input terminals for receiving the input power from the input terminal, and for transforming the input power into a charging power and a supply power, and
a bidirectional converter for providing the charging power to the energy storage device in the first mode and for providing discharge power to the LED load in the second mode.

4. The lighting device according to claim 1 wherein the power converter is a multiple output converter arranged to provide charging power to the energy storage device via one of the multiple outputs in the first mode and provide supply power to the LED load via another of one of the multiple outputs in the first mode.

5. The lighting device according to claim 1 wherein the power converter comprises a switched mode power supply.

6. The lighting device according to claim 1 wherein the controller has an input for receiving an external control signal for overruling the switching from the first mode to the second mode or the switching from the second mode to the first mode.

7. (canceled)

8. The lighting device according to claim 1 wherein the lighting device is configured to switch to the second mode when the lighting device is in stand-by, requiring a stand-by power and when the charge level is above the lower threshold (THL).

9. A system comprising:
the lighting device as claimed in claim 1; and
an external device for providing power to the input terminal and receiving power from an AC supply.

10. A system according to claim 8 wherein the lighting device is arranged for drawing in the first mode the input power within a rated power range of the external device.

11. The system according to claim 8 wherein the external device is arranged to be one of a phase-cut dimmer, a ballast of a gas discharge lamp, a ballast of a high intensity discharge lamp and an electronic ballast.

12. A method for controlling a lighting device for operating with a fluorescent ballast,
receiving an input power,
transforming the input power into a charging power and a supply power;
storing the charging power in an energy storage device;
supplying the supply power or a discharging power from the energy storage device to an LED load,
determining the charge level of the energy storage device;
switching the lighting device into a first mode when a charge level of the energy storage device is below a lower threshold level (THL);
switching the lighting device into a second mode when the charge level exceeds an upper threshold level (THU),
wherein in the first mode the supply power is supplied to the LED load, and the charging power is supplied to the energy storage device and wherein in the second mode the discharging power is supplied to the LED load.
